(19) United States
(12) Patent Application Publication
(10) Pub. No.: US 2026/0003594 A1
(43) Pub. Date: Jan. 1, 2026

(54) UNIVERSAL WEB APPLICATION INSTALLATION

(71) Applicant: GOOGLE LLC, Mountain View, CA (US)

(72) Inventors: Penelope McLachlan, Bowen Island (CA); Peter Beverloo, London (GB); Hanqing Ge, Kitchner (CA); Glenn Hartmann, Kitchner (CA)

(21) Appl. No.: 18/995,646

(22) PCT Filed: Sep. 6, 2023
(86) PCT No.: PCT/US2023/073549

§ 371 Date: Jan. 16, 2025

Related U.S. Application Data
(60) Provisional application No. 63/374,974, filed on Sep. 8, 2022.

(51) Int. Cl. G06F 8/61; G06F 3/04817; G06F 21/57

(52) U.S. Cl. CPC G06F 8/61; G06F 3/04817; G06F 21/572

(57) ABSTRACT

Methods are disclosed for making installable web applications more widely available, helping users to find and install web applications on their computing devices. Some methods help surface an install control to initial installation. Some methods provide generate manifest files for web sites not associated with an installable web application. Some methods provide default offline capabilities for installable web applications.

### CROSS REFERENCE TO RELATED APPLICATION

This application claims the benefit of U.S. Provisional Application No. 63/374,974, filed Sep. 8, 2022. The disclosure of which is incorporated herein by reference in its entirety.

### BACKGROUND

Some applications offered through an app store are actually installable web applications rather than native applications. A native application is fully installed on the client device and may not depend on a browser to execute, although such an application may rely on a connection with a server for some content. A web application is a webpage with executable code. Some of the code may execute on a server and some code may run in the browser sandbox without installing code into the underlying operating system on the client device. A Web application executes within a browser sandbox, e.g., in a main browser window (also called a tabbed window). In other words, a web application is clearly executing within the browser. An installable web application is a hybrid, with some code installed into the underlying operating system on the client device, some code executing at the server, and relying upon the browser (e.g., a main browser window) to execute, although the application does not clearly look like it is running in a main browser window. Installable web applications are able to use local resources (such as the camera, GPS, access files-all with user permission) and have some offline functionality, but some functionality occurs by running code at the server.

### SUMMARY

This disclosure is related to making any web application installable and at least partially executable on the client device, e.g., as an installable web application. In other words, disclosed implementations can enable a user to install any webpage as an installable web application. Some implementations enable a user to more easily locate and install progressive web applications. For example, one technique analyzes the webpages of a domain to determine whether a webpage (a resource, e.g., identified by a URL) exists that meets legacy criteria for an installable web application. If a domain includes a webpage that supports the legacy criteria, implementations may offer an install control in the browser interface, e.g., in the omnibox or bottom of the browser UI. Some implementations may ease (modify) the legacy criteria for installing a web application, enabling more web applications to be installable web applications. Such techniques can eliminate the need for the web application to register a Service Worker by providing a default offline page. Some implementations can eliminate the need for a manifest file by providing default manifest settings. Some implementations can eliminate all legacy criteria, enabling the user to install any web application.

The details of one or more implementations are set forth in the accompanying drawings and the description below. Other features will be apparent from the description and drawings.

### BRIEF DESCRIPTION OF THE DRAWINGS

FIGS. 1A-1C illustrate example interfaces, according to some aspects.

FIGS. 2A and 2B illustrate example interfaces, according to some aspects.

FIG. 3 illustrates an example browser interface, according to an aspect.

FIG. 4 illustrates an example browser overflow menu, according to some aspects.

FIG. 5 illustrates a system for providing a universal web application installation, according to an aspect.

FIG. 6 illustrates an example browser update interface, according to some aspects.

FIG. 7 is a flow diagram, according to an aspect.

FIG. 8 is a flow diagram, according to an aspect.

### DETAILED DESCRIPTION

Disclosed implementations relate to techniques that make any web application installable. A website that supports an installable web application must meet certain criteria, e.g. . . . , be served over HTTPS, have a manifest file, and register a Service Worker with a ‘fetch’ event handler (e.g., a service worker that responds with a HTTP 200 status code in a simulated offline environment). This criteria is referred to herein as legacy criteria. Many web applications do not meet this legacy criteria and therefore are not considered installable (e.g., are not considered to support an installable web application). Moreover, many entities (e.g., application developers, website operators) offer an installable web application in addition to a native application and/or a web application. A web application and an installable web application from the same entity may be offered from different subdomains. For example, a web application may be offered at www.company.com where similar content is also offered as an installable web application via app.company.com. Some developers that have a native application and an installable web application may hide the existence of the installable web application from certain users, e.g., using the country code of a user to determine whether the user has access to the installable web application rather than the native application. Most installable web applications are implemented to look like a native app to the user, so the user cannot necessarily tell whether the app is a native app or an installable web application.

Installable web applications have technical advantages over native applications and web applications. Installable web applications use less storage on the client device than a native application, and also take less time and bandwidth to download and install. Installable web applications may also load faster than web applications (due to the caching of text, stylesheets, images, etc.) and faster than native apps (because load time is related to the size of the app itself). Thus, installable web applications provide a technical benefit by making the advantages of an installable application broadly available to any web application, which reduces code redundancy (e.g., the need for separate native applications and web applications is decreased), reduces use/consumption of system resources on installation, and decreases load time.

Implementations provide the technical advantages through techniques for making any web-based content installable on a user device, thus erasing the line between web applications and installable web applications. Implementations can enable the user to define the access, e.g., opting to either bookmark (also referred to as saving a favorite or an Internet shortcut) a particular webpage for later use or to install the webpage as an application on the client device (e.g., an installable web application). Implementations thus eliminate the legacy criteria that defines web-based content (web applications) as installable, providing install-ability for webpages that do not currently meet legacy criteria.

Implementations dramatically expand the number of installed web applications available to a user, thus enabling more user devices to benefit from the advantages of installed web applications. Some implementations make it easier for users to find web applications that meet existing legacy criteria. Some implementations reduce or eliminate the criteria for installing a web application. Thus, implementations also make it easier for entities (e.g., application developers, website operators, etc.) to offer their content using an installed web application, including adding an install prompt on their content pages. For example, in some implementations, the entities need not do anything to make the webpage installable as the disclosed techniques can make any webpage installable. This in turn, encourages users to take advantage of the optimizations and technical advantages offered in an installed web application.

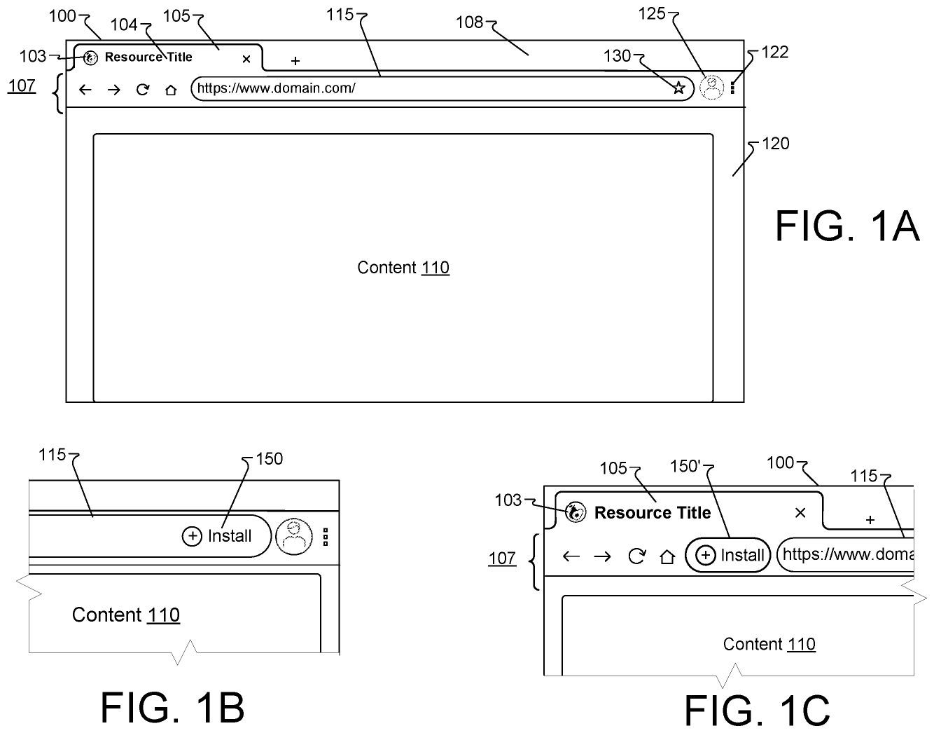

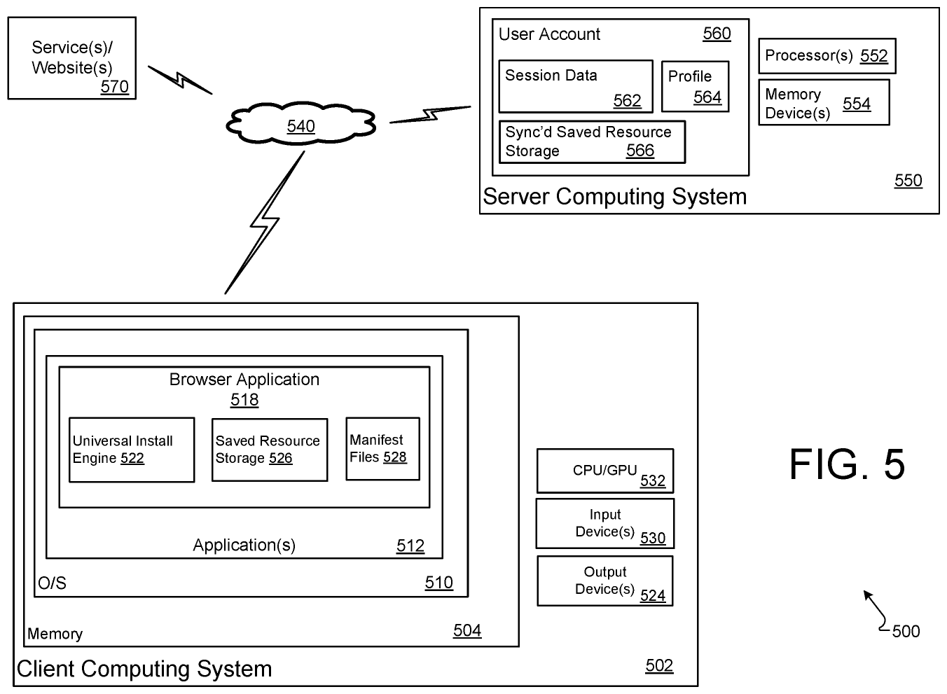

FIG. 1A illustrates an example browser interface (UI) 100, in accordance with implementations described herein. In general, the UI 100 is generated and rendered by a browser. A browser can be a browser-based operating system (such as operating system 510 of FIG. 5) or an application executed by the operating system (e.g., browser application 518 of FIG. 5). Thus, as used herein, browser refers to either a browser-based operating system or a browser application. The UI 100 includes a tab strip 108 associated with the browser. In this example, the UI 100 includes one browser tab 105, although any number of browser tabs or tab groups can be opened by the browser. Each browser tab, e.g., browser tab 105, may be associated with content 110 (e.g., web content, a webpage, an online resource, web application, etc.) presented in a corresponding browser content window 120 of the browser. The browser tab 105 may include icon 103 and title 104. The icon 103 and title 104 are selected by the developer of the website associated with the content 110. The icon 103 may also be referred to as a favicon or an apple-touch-icon. As used herein, the content 110 refers to any content rendered by the browser, which may be generated or served at least partially by/from a server. Content 110 generated or served at least partially by a server is referred to as a webpage provided by a website. A website is content associated with a domain. The domain is a resource identifier, identifying a particular server (or group of servers) that provides the content for the website. The domain is a primary resource identifier. A domain may include one or more web applications identified using a subdomain. The subdomains may be identified as preceding the domain in the resource identifier. For example, blog.company.com is a subdomain of the domain company.com, as is app.company.com. Likewise, www.company.com is a subdomain of the domain company.com. This domain is an inferred subdomain, e.g., if no subdomain is given, the subdomain of www may be inferred. All subdomains of a domain are considered part of the website associated with the domain. A resource identifier of a content item thus includes a domain and a subdomain and may include additional parameters (e.g., directories, locations, parameter variables, etc.) that identify a web application (webpage) provided by the website. Examples of resource identifiers are URLs (Universal Resource Locators) or URIs (Universal Resource Identifiers). In addition, as used herein, content refers to the webpage (resource) currently rendered in the browser content window 120 as well as any other data (metadata) that is used to render the document (e.g., markup and scripts that are not actually displayed), and models generated for rendering the content 110 (e.g., document object models, accessibility models, etc.).

The UI 100 also includes an address bar area 107. An address of the webpage displayed in the browser content window 120 can be illustrated in the address bar area 107 (e.g., in address input area 115). The address input area 115 enables a user to provide, for example, a resource identifier for a content item. The address input area 115 can also be used for searching, e.g., for entering search terms that are provided to a search engine. An address input area 115 with this additional capability can be referred to as an omnibox. Other controls, icons, and/or so forth can be included in the address bar area 107. For example, the address bar area 107 can include a user icon 125. The user icon 125 may provide an indication of a user account associated with the browser session. This user icon 125 can be an image, text, or some other representation of the user account. Other controls/icons conventionally included in the address bar area 107 include a forward control, a back control, a refresh control, a home control, an extensions control, and/or a saved resource control 130, and an overflow menu control 122. The address bar area 107 can be controlled by and/or associated with the browser (e.g., the operating system 510 or the browser application 518). The content of the address bar area 107 can be controlled by the browser, whereas the content of the browser content window 120 is controlled by the website developer, although some user interface elements of the address bar area 107 can be influenced by manifest file options for installed web applications, e.g., using Window Control Overlays. The saved resource control 130 is used to add the resource identifier (e.g., the URL) of the content 110 to a saved resource storage area, e.g., local saved resource storage 526 of FIG. 5. The saved resources can be referred to as bookmarks, favorites, internet shortcuts, and the like. FIG. 1A illustrates an example UI 100 for a display with a normal form factor, e.g., a display of a laptop, a desktop, a tablet, etc.

In one aspect, implementations provide an install control (e.g., illustrated in FIGS. 1B, 1C, 2A, 2B, 3, and 4) when a user visits a domain that supports an installable web application and the user has not already installed the installable web application. A domain supports an installable web application when the domain includes a resource (web application) that satisfies legacy criteria. The legacy criteria includes serving the web application over a secure communication protocol (e.g., via HTTPS or similar secure communication protocol), the web application has a manifest with required fields, and the web application registers a Service Worker with a fetch event handler. The required fields for a manifest can include a display name for the web application, icons for the web application in two sizes, a start location (e.g., a start URL), a display mode (e.g., one of fullscreen, standalone, or minimal-ui), and a prefer-related-applications field that is not present (e.g., false). The fields in a manifest file can be defined by the w3c org at https://www.w3.org/TR/appmanifest/. In some implementations, the browser may determine whether the current domain includes a webpage that meets this legacy criteria and, if so, provide an install control (e.g., 150, 150′, 250, 250′, 350, 450), giving the user the opportunity to install the web application represented by the webpage as an application on the client device. In other words, the user may be viewing a webpage different from the webpage that satisfies the legacy criteria, so may be unaware that the domain offers an installable web application. In some implementations, the browser may also provide the install control (e.g., 150, 150′, 250, 250′, 350, 450) in response to determining that the web application meets an engagement threshold. For example, the browser may not provide the install control unless a minimum number of users have opted to install the web application associated with the domain.

FIG. 1B illustrates the example browser user interface of FIG. 1A with an install control 150 added to the address input area 115, according to an aspect. In the example of FIG. 1B, the UI 100 is only partially shown, e.g., representing the upper right portion of the UI 100 of FIG. 1A. In the example of FIG. 1B, the install control 150 replaces the saved resource control 130 for content 110. In other examples, the install control 150 can be added next to (proximate) a saved resource control 130. In the example of FIG. 1B, the browser has analyzed the domain of the webpage currently displayed, e.g., using universal install engine 522 of FIG. 5, to determine whether the domain is associated with a web application (e.g., any resource associated with the domain, such as a webpage associated with a subdomain or a path) that meets installable application criteria and that the user has not yet installed the web application. If the website does include such a web application (e.g., app.domain.com, www.domain.com/moble, m.domain.com, www.domain.com/m/app, etc.) and the user has not installed the web application associated with this domain, the browser may add (surface) the install control 150. In some implementations, the installable application criteria can include legacy install criteria. In some implementations, the installable application criteria may include the existence of a manifest file. In some implementations, the installable application criteria may include the lack of an install method associated with the installable webpage, i.e., an install method provided by the domain does not exist. In some implementations, the installable application criteria may include the webpage being a root of origin page without an install method or manifest file. A root of origin page represents a webpage with a resource locator (URL) having a top-level domain, and a second-level domain but no subdirectory. For example, example.resource.com is a root of origin page but example.resource.com/location is not because it includes a subdirectory. In other words, any webpage that represents a root of origin page can meet the install criteria, even one lacking association with a manifest file. Association with a manifest file means that the manifest file is available through the website that provides the root origin page. In some implementations, the installable application criteria may include a heuristic (e.g., meeting an installation threshold where a minimum number of users have installed the application). In some implementations, the installable application criteria may include a mechanism (e.g., a service worker with a fetch event handler) for the website to be available offline. Install control 150 is configured to install the web application associated with the installable webpage when selected by the user. Installation of the web application includes downloading a manifest file to the client device. In some implementations, installation of the web application includes creating an operating system package file (e.g., an APK) on behalf of the website (the domain). The operating system package file helps the website distribute and install the application on the client device. As described herein, in some implementations, the browser may generate or add to the manifest file as part of the installation process.

FIG. 1C illustrates the example browser user interface of FIG. 1A with an install control 150′ added to the address bar area 107, according to an aspect. In the example of FIG. 1C, the UI 100 is only partially shown, e.g., representing the upper left portion of the UI 100 of FIG. 1A. In the example of FIG. 1C, the browser has analyzed the website associated with the content 110, as described in FIG. 1B and determined that the domain supports installable application criteria (including, in some implementations, the heuristic) but the user has not installed the application. FIG. 1B illustrates an alternative placement of the install control 150.

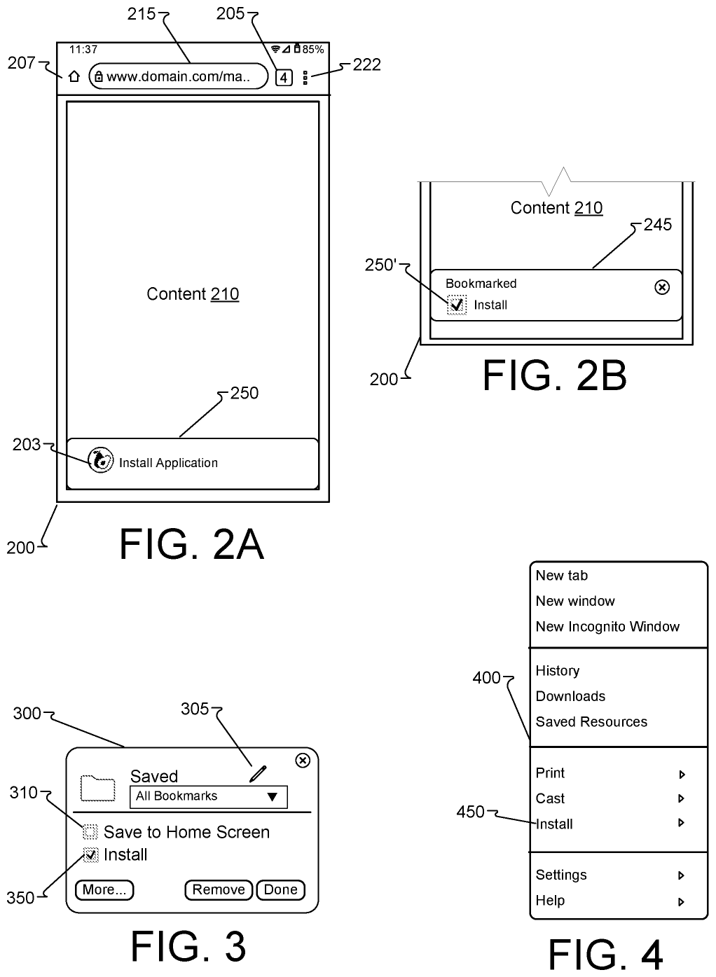

FIG. 2A illustrates an example browser user interface (UI) 200 with an install control 250 for a client device with limited display area, according to an aspect. The device is an example of mobile devices, such as smart phones, smart wearables, tablets, etc. that have less display area than devices with a normal display area, e.g., conventional computer monitors and TVs, etc. However, the UI 200 includes elements similar to those described in FIG. 1A, including an address bar area 207 similar to address bar area 107, an address input area 215 similar to the address input area 115 and overflow menu control 222 similar to overflow menu control 122. Because of the limited display area, the UI 200 may include an indication 205 of the number of tabs open which, when selected, enables the user to select a different browser tab. Content 210 may be similar to content 110, e.g., representing content associated with the resource identifier displayed in the address input area 215.

In the example of FIG. 2A, the browser has analyzed the website, e.g., using universal install engine 522 of FIG. 5, and determined that the website is associated with a resource in the domain scope that meets application installation criteria (e.g., an installable web application) and that the user has not yet installed the application, as described above. Thus, the browser provides install control 250, which like install control 150, when selected is configured to install the associated web application. Accordingly, even if the user is not viewing content 210 associated with the installable web application, the browser may still provide install control 250. The install control 250 can include icon 203. Icon 203 may be an icon listed in a manifest file for the website. If a manifest file is not found, icon 203 may be icon 103 of FIG. 1A, e.g., an icon a developer of the website associates with the website.

FIG. 2B illustrates a partial view of the UI 200 with an install control 250′. In the example of FIG. 2B, the user has provided an instruction to save the content 210 as a saved resource (e.g., saved it as a bookmark or favorite). This may be done using a saved resource control similar to saved resource control 130, a menu option, etc. In the example of FIG. 2B, the browser may provide a confirmation window 245, indicating the content 210 is saved, e.g., in local saved resource storage 526. If the browser determines (e.g., in response to determining) that a website associated with the saved resource offers an installable web application that meets installable application criteria and the user has not already installed the web application, the browser may offer the install control 250′ as part of the confirmation window 245. The install control 250′ may initially be unchecked and may be configured, when the user checks/selects the install control 250′, to install the web application. In some implementations, the browser may be configured to install the web application when the user closes the confirmation window 245 after checking/selecting the install control 250′. Although illustrated as a checkbox, any selectable control can be used as install control 250′.

FIG. 3 illustrates a confirmation window 300 with an install control 350 for a saved resource. The confirmation window 300 may be provided by the browser after a user has bookmarked/favorited a resource identifier. The confirmation window 300 may be a pop-up window that overlays content in a browser tab. The confirmation window 300 may include a control 305 for changing a title or folder (location) of the saved resource. The confirmation window 300 may include a shortcut control 310 and the install control 350. The shortcut control 310 may add a shortcut to the webpage on the home screen, which may be customized by a manifest file downloaded from the website, but does not install other code on the client device. In some implementations the install control 350 may appear for any webpage that has been saved in the saved resources. In some implementations, the install control 350 may be provided if the website associated with the saved resource has a web application that meets installable application criteria, as discussed herein.

In some implementations, the shortcut control 310 and install control 350 are also settings in the saved resource (e.g., bookmark) properties page/manager UI (not shown), so that the user can change these selections in the future. The bookmark manager UI is displayed in response to the user selecting edit (e.g., control 305) after saving the resource identifier. In some implementations, the browser may verify whether the user has removed the shortcut from their home screen/desktop. Thus, before displaying shortcut control 310 the browser may verify whether the icon has been removed from the home screen/desktop and uncheck the shortcut control 310 if it has. Similarly, before displaying install control 350 the browser may verify whether the app is installed and, if not, uncheck the install control 350. This would ensure that the user could re-add to the home screen or reinstall the app by selecting the appropriate controls again.

FIG. 4 illustrates an example overflow menu 400, according to disclosed implementations. The overflow menu 400 may be generated and displayed by the browser in response to a user selecting overflow menu control 222 of FIG. 2A or overflow menu control 122 of FIG. 1A. The overflow menu 400 includes, among other menu options, install control 450. The install control 450, like install control 350, install control 250, install control 250′, install control 150, and install control 150′, may be configured to install a web application associated with the website currently displayed by the browser in a browser content area. The install control 450 may, in some implementations, only be selectable (active) if the currently displayed content (e.g., content 110 of FIG. 1A, content 210 of FIG. 2A) is associated with a webpage that meets installable application criteria and the user has not already installed the web application, as disclosed herein.

In addition to surfacing the install controls, implementations may provide various techniques for making all web applications installable and/or for improving the functionality of the installed web applications. In some implementations, where the webpage provides a manifest file but lacks offline functionality, the browser may provide default offline functionality. The default offline functionality is also referred to as a default offline page. An offline page, including a default offline page, is provided by the browser when the client device lacks a connection to the domain (e.g., lacks a connection to the Internet). Browsers have a default offline page (browser's default offline page), but this page is generic. Put another way, the browser's default offline page is the same regardless of what website (domain) the user is attempting to access. For installed web applications, the manifest can provide a graceful offline experience by providing offline elements for the installed web application. But no manifest fields are mandatory. Thus, an installed web application may have a manifest file, but the manifest file may lack values, i.e., is missing values, for some of the offline page elements in the manifest file that support offline functionality.

In disclosed implementations, the browser may be configured to provide defaults for these missing offline page elements, making the user experience more consistent. Disclosed implementations may also provide defaults for a web application that lacks a manifest, e.g., using the following defaults to generate a manifest. For example, if the manifest file lacks a name for the installed web application, the browser may use a page title for the name. A page title is identified using markup language (e.g., HTML), so can be easily identified. As another example, if the manifest file lacks a name for the installed web application, the browser may prompt the user for a name. In some such implementations, the browser may suggest the page title as the name but provide the user an opportunity to change the name. As another example, if a manifest file lacks a background color, the browser may select a default color. In some implementations, the default color can be white. In some implementations, the default color can be black. In some implementations, the default color may be determined by the dark mode of the client device (e.g., some client devices use a white background during the day/when ambient light meets a minimum threshold and switch to a black background at night/when ambient light fails to meet the minimum threshold). In some implementations, the background color may match a background color determined by a color scheme the user has selected for the browser. In some implementations, the browser may set the background color to the background color value set in the body of a style sheet for the webpage. In some implementations, the browser may set the background color to a “theme-color” meta tag included in the webpage. As another example, if the manifest lacks an offline string (i.e., a message indicating the device is offline), the browse may provide a default offline string.

As another example, if a manifest file lacks an icon, the browser may select an icon, such as icon 103, associated with the website. The icon 103 is a file containing one or more small icons used by a particular website or webpage, typically displayed in the tab along with the title of the website. Thus, the developer specifically associates the icon with the website. In some implementations, the browser provides the default offline page when (in response to determining) the app is installed and the web application lacks an offline experience powered by a service worker with a fetch event handler. In some implementations, a new additional field may be added to a manifest file that indicates the browser should not use the default offline mode. Thus, for example, a manifest file may include a default_offline_page flag (Boolean) that is set to false. If this default offline flag is present in the manifest file and set to false, the browser may not show the default offline page. This new field in the manifest file enables a developer to control the use of the default offline page for their web application.

In some implementations, the default offline functionality may be enhanced by additional information in the manifest file. Thus, if a developer does not provide full offline functionality, the developer may elect to provide one or more of the following elements. In some implementations, the manifest may include an offline purpose attribute for an icon in the manifest file. The offline purpose attribute (e.g., purpose=offline) of the icon may cause the browser to prioritize the icon for the centered offline image. For example, a developer may want to display a slightly different icon when the app is offline than the icon used on the home screen. For example the icon with the offline purpose attribute may be a version of the main icon that has a different appearance (grayed out, black and white, more transparent, etc.). In some implementations, the manifest may include the default offline flag, mentioned above, which controls whether the browser provides the default offline page. If this flag indicates the developer does not want the browser using the default offline page, the browser may not provide the default offline page and instead provide the browser's default offline page/message.

In some implementations, if a website lacks a manifest file, the browser may generate a manifest file for the website to enable a user to install the website. The browser may use the page title as the application name in the manifest file and/or ask the user to specify a name for the application. The browser may use the current resource identifier, e.g., the current URL, as the start resource identifier (e.g., start_url) in the manifest file. In some implementations, query parameters may be included in the start resource identifier field of the manifest. In some implementations, fragments are excluded from the start resource identifier. In some implementations, a root of the current origin is used as the application scope. The root of the current origin is the subdomain, second-level domain, and top-level domain of a current resource identifier.

FIG. 5 illustrates a system 500 for providing universal install, according to an aspect. The system 500 includes a client computing system 502. The client computing system 502 may also be referred to as a client computing device or just a client device. The client computing system 502 is a device having an operating system 510. In some examples, the client computing system 502 includes a personal computer, a mobile phone, a tablet, a netbook, a laptop, a smart appliance (e.g., a smart television), or a wearable. The client computing system 502 can be any computing device with input devices(s) 530, such as a mouse, trackpad, touchscreen, keyboard, virtual keyboard, camera, etc. The client computing system 502 can include output device(s) 524, such as a display (monitor, touchscreen, etc.) that enables a user to view and select displayed content. The client computing system 502 may include one or more processors, such as CPU/GPU 532, formed in a substrate configured to execute one or more machine executable instructions or pieces of software, firmware, or a combination thereof. The processors, such as CPU/GPU 532, can be semiconductor-based—that is, the processors can include semiconductor material that can perform digital logic. The client computing system 502 may include one or more memory devices 504. The memory devices 504 may include a main memory that stores information in a format that can be read and/or executed by the CPU/GPU 532. The memory devices 504 may store applications or modules (e.g., operating system 510, applications 512, browser application 518, etc.) that, when executed by the CPU/GPU 532, perform certain operations.

The operating system 510 is a system software that manages computer hardware, software resources, and provides common services for computing programs. In some examples, the operating system 510 is operable to run on a personal computer such as a laptop, netbook, or a desktop computer. In some examples, the operating system 510 is operable to run a mobile computer such as a smartphone or tablet. The operating system 510 may include a plurality of modules configured to provide the common services and manage the resources of the client computing system 502. The client computing system 502 may include one or more input devices 530 that enable a user to select content, select controls, etc. Non-exclusive example input devices 530 include a keyboard, a mouse, a touch-sensitive display, a trackpad, a camera, a trackball, and the like. The client computing system 502 may include one or more output devices 524 that enable a user to view a webpage and/or receive audio or other visual output.

The client computing system 502 may include applications 512, which represent specially programmed software configured to perform different functions. One of the applications may be the browser application 518. The browser application 518 may be configured to display webpages, execute web applications, and the like. The browser application 518 may include additional functionality in the form of extensions. In some implementations, the browser application 518 may also be the operating system 510 of the client computing system 502, e.g., similar to the CHROME OS. The browser application 518 is an example of the browser that generates the UI 100 of FIG. 1A or the UI 200 of FIG. 2A. The operating system 510 can also be an example of the browser that generates the UI 100 of FIG. 1A. The browser application 518 may include local saved resource storage 526. The local saved resource storage 526 may be a data store where saved resources (bookmarks, favorites, internet shortcuts, etc.) are stored. In some implementations, a user may opt to synchronize saved resources with a user profile. In such implementations, the use may have a user account 560 on a server computing system 550 and periodically the local saved resource storage 526 may be sent to the server computing system 550 so that the synchronized saved resource storage 566 can be updated with the user's local saved resource storage 526. However, because the saved to home screen and installation status of a particular resource are device dependent, these values may not be included in the information synchronized. The user has control over the synchronization process.

Put another way, a user may be provided with controls allowing the user to make an election as to both if and when the saved resources, including any attributes/metadata associated with a saved resource, are saved in the local saved resource storage 526, and if, when, and how much of the information stored in the local saved resource storage 526 is synchronized with the user's profile, e.g., shared with the server computing system 550. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

The browser application 518 may include universal install engine 522. Universal install engine 522 can provide the default offline page functionality and/or the default manifest functionality and/or the surfacing of the install controls, as described herein. For example, the universal install engine 522 may analyze resources of a website displayed by the browser application 518 to determine whether the website meets installable application criteria. In some implementations, the installable application criteria may be legacy criteria. In some implementations, the installable application criteria may include the existence of a manifest file, i.e., if the website is associated with a manifest file the website meets the installable application criteria. In some implementations, the installable application criteria may include the lack of an install method associated with the installable webpage. For example, a website that provides an install method (e.g., a selectable control that, in response to selection, initiates installation of a web application for the website) may not meet the installable application criteria. In some implementations, the install criteria may include that the webpage is a root of origin page and the domain lacks an associated manifest file (e.g., a manifest file associated with the domain does not exist). For example, www.resource.com is a root of origin page and would meet the installable application criteria but www.resource.com/location is not and would not meet the installable application criteria. In some implementations, the installable application criteria may include a heuristic. For example, the heuristic may relate to attributes of the website and/or an installable web application for the website (e.g., determining that a minimum number of users have installed the application, determining a minimum satisfaction capability (e.g., based on user reviews, a relationship between installs and uninstalls, a length of time between an install and uninstall (e.g., average length of time or the like), etc.). In some implementations, the installable application criteria may include availability of a mechanism for the website to be available offline. The installable application criteria can include one of the above (e.g., may be a single criterion). The installable application criteria can include any combination of two or more of the above criteria.

The universal install engine 522 may provide (surface) an install control if the installable application criteria is met. Install control 150, install control 150′, install control 250, install control 250′, install control 350, and install control 450 are examples of an install control. In some implementations, part of the analysis may be determining whether the user has installed the web application for the website. In some implementations, if already installed the universal install engine 522 may not provide (surface) the install control. In some implementations, if already installed the universal install engine 522 may inactivate the install control.

The universal install engine 522 may facilitate installation of a webpage as an installable web application. For example, if the universal install engine 522 provides an install control, the universal install engine 522 may handle installation of the web application in response to selection of the control. As another example, the universal install engine 522 may handle installation of the web application in response to selection, by the user, of an install method provided by the website. Regardless of what process invoked the instruction to install a web application, the universal install engine 522 may determine whether or not the website is associated with a manifest file. If the website is not associated with a manifest file, the universal install engine 522 may generate a manifest file. In generating the manifest file, the universal install engine 522 may use the webpage title as the application name in the manifest file. The universal install engine 522 may use the current resource identifier, e.g., the current URL, as the start_url in the manifest file. In some implementations, query parameters may be included in the start_url field of the manifest. In some implementations, fragments may be excluded from the start_url. In some implementations, a root of the current origin is used as the application scope in the manifest file. In some implementations, the universal install engine 522 may provide a background color for the manifest file. The universal install engine 522 may select a default color. In some implementations, the default color can be white. In some implementations, the default color can be black. In some implementations, the default color may be determined by the dark mode of the client computing system 502. In some implementations, the background color may match a background color determined by a color scheme the user has selected for the browser. In some implementations, the universal install engine 522 may identify an icon for the manifest file. The icon may be an icon associated with the website, e.g., an icon the website developer specifically associates with the website. Generation of the manifest file for a website may make any website an installable web application.

If a manifest file is associated with the website, the universal install engine 522 may determine whether the manifest file includes offline functionality. For example, if the manifest file does not include any of the offline page elements described above, and does not have a default_offline_page flag (i.e., a default offline flag) set to false, the universal install engine 522 may provide defaults for the offline page elements. The default offline functionality is defined by offline page elements in the manifest file. These default offline page elements generate a default offline page. The universal install engine 522 may be configured to provide defaults for any missing offline page elements. The offline page elements can include an application name, background color, an offline string, and/or an icon. The manifest file for the installable web application, whether it was generated by the universal install engine 522, modified by the universal install engine 522, or unchanged by the universal install engine 522, may be stored on the client computing system 502, e.g., in manifest files 528, as part of installing the web application.

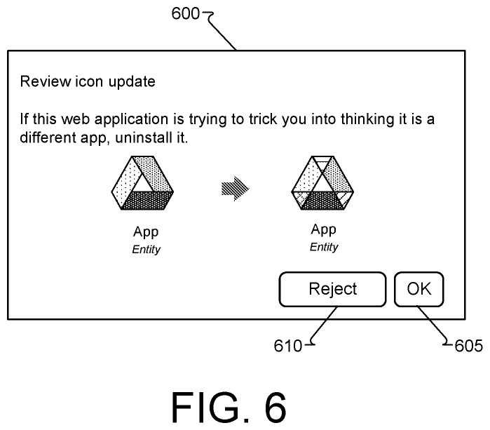

If the universal install engine 522 generates a manifest file for a website that did not have a manifest file, but the developer later adds a manifest file, the browser application 518 may treat this event as an update of the installed application. For example, the browser application 518 may include an automatic update process that periodically pings the website associated with an installed web application to determine if the manifest file has changed. As another example, the user may direct the browser application 518 to check for an update. To protect against spoofing, unintended modifications, etc., the browser application 518 may provide a verification process for updating the installable web application. Thus, for example, the browser application 518 may provide a dialog showing differences between the current manifest (e.g., the manifest generated by the universal install engine 522) and the new manifest. The dialog is a pop-up message or window that enables the user to verify the update. The dialog may include the old icon and application name (e.g., from the generated manifest) and the new icon and application name (e.g., from the manifest file added by the developer). The dialog may include text notifying the user that the application has changed. The dialog may include controls that enable the user to accept the change, which results in the new manifest being downloaded and saved on the client computing system 502, e.g., in manifest files 528. The dialog may be displayed to the user. FIG. 6 is an example of an update dialog 600 generated by the browser application 518 in response to determining that the manifest file has changed. In the example of FIG. 6, the update dialog 600 includes the icons, application names, and entities (e.g., company, developer, etc.) associated with the installable web application. In addition, the update dialog 600 includes an accept change control 605 and a reject change control 610. In some implementations, the reject change control 610 may cancel the update to the application. In some implementations, the reject change control 610 may uninstall the installable web application.

The browser application 518 can also include or be associated with a local saved resource storage 526. The local saved resource storage 526 is a data store where saved resources (bookmarks, favorites, shortcuts, etc.) are stored. Each entry in the local saved resource storage 526 represents a content item, e.g., a webpage or document. The content item can be accessible via a network 540 from a service(s)/website(s) 570. In some implementations, the content item can be stored locally, e.g., in memory devices 504. Each entry in the local saved resource storage 526 can have a content identifier. The content identifier uniquely identifies the content item. The content identifier can be a resource identifier, such as a URI or URL. The content identifier can also be a unique identifier for a non-Internet domain. The entry may also include a title or description for the saved resource. The entry may include an add or creation time. The add (creation) time represents the time at which the saved resource was added to the local saved resource storage 526.

In some implementations, the local saved resource storage 526 may be associated with a user profile. In other words, more than one user may have access to the client computing system 502 and may use the browser application 518. In such scenarios, the local saved resource storage 526 may be associated with a user profile, so that each user of the browser application 518 may have a separate respective local saved resource storage 526. In some implementations, the user may opt for saved resource synchronization. Saved resource synchronization may be initiated by the user on the client computing system 502. After initiating saved resource synchronization on the client computing system 502, the local saved resource storage 526 may be shared with a user account 560 for the user on server computing system 550.

In some examples, the client computing system 502 may communicate with a server computing system 550 over a network 540. The server computing system 550 may be a computing device or computing devices that take the form of a number of different devices, for example a standard server, a group of such servers, or a rack server system. In some examples, the server computing system 550 may be a single system sharing components such as processors and memories. The network 540 may include the Internet and/or other types of data networks, such as a local area network (LAN), a wide area network (WAN), a cellular network, satellite network, or other types of data networks. The network 540 may also include any number of computing devices (e.g., computer, servers, routers, network switches, etc.) that are configured to receive and/or transmit data within network 540. Network 540 may further include any number of hardwired and/or wireless connections.

The server computing system 550 may include one or more processors 552 formed in a substrate, an operating system (not shown) and one or more memory devices 554. The memory devices 554 may represent any kind of (or multiple kinds of) memory (e.g., RAM, flash, cache, disk, tape, etc.). In some examples (not shown), the memory devices 554 may include external storage, e.g., memory physically remote from but accessible by the server computing system 550. The server computing system 550 may include one or more modules or engines representing specially programmed software. For example, the server computing system 550 may include systems for managing and accessing user account(s) 560. The user accounts 560 may include data that a user has requested to be synchronized across devices, such as client computing system 502. The synchronized data can include session data 562. The session data 562 can enable a user to resume browsing activity after switching devices. The user account 560 may also include profile data 564. The profile data 564 may include, with user consent, information describing the user. The profile data 564 may also include data that identifies a user (e.g., a username and password). The user account 560 may also include synchronized saved resource storage 566. The saved resource storage 566 may be a data store of saved resources for the user across devices. For example, as part of a synchronization activity the local saved resource storage 526 may be sent from the client computing system 502 to the server computing system 550 and saved in saved resource storage 566.

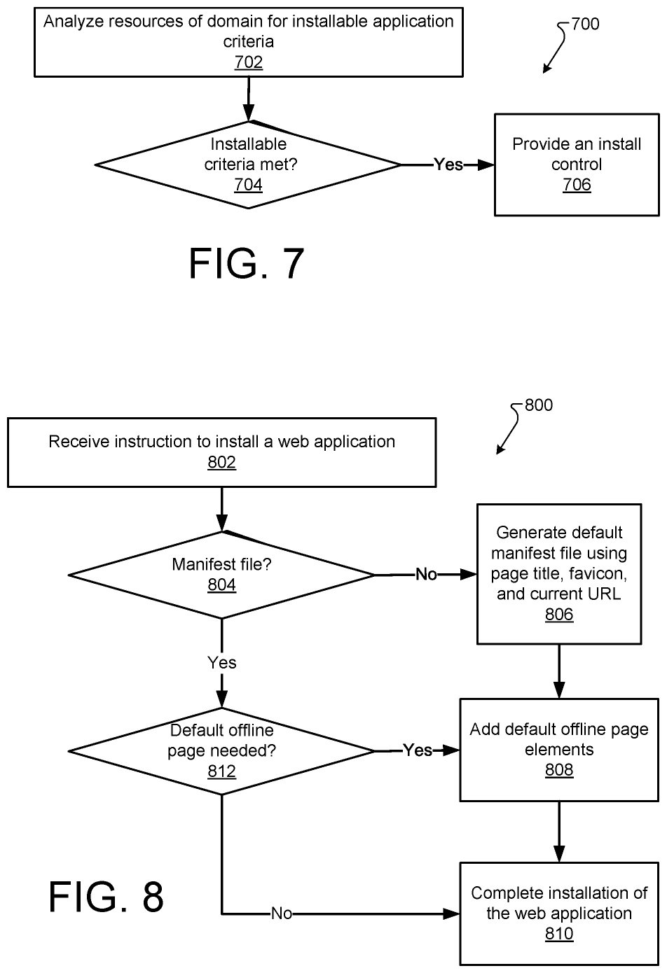

FIG. 7 is a flowchart depicting a method with example operations 700 for surfacing an install control in a browser of a computing system that supports universal web application install, according to an implementation. The operations 700 may be performed by a system, such as client computing system 502 of FIG. 5. In some implementations, the operations 700 may be performed by a browser application 518 and/or a universal install engine 522 of the client computing system 502. The operations 700 enable the system to proactively suggest installing a web application for a website that the user is visiting that meets installable application criteria. At step 702 the system analyzes the resources of a domain to determine whether the resources of the domain meet installable application criteria. At step 704 the system determines whether the installable application criteria is met. In some implementations, step 702 can include analyzing resources of the computing system to determine whether the computing system has already installed the installable web application for the website. If so, in some implementations, this may cause the system to determine that the installable application criteria is not met. If the installable application criteria is met, at step 706 the system may provide an install control for the website. The install control is any selectable control configured to, in response to selection by the user, initiate an instruction to install the web application on the computing system.

FIG. 8 is a flowchart depicting a method with example operations 800 for generating a default manifest file and providing offline pages in a browser of a computing system that supports universal web application installation, according to an implementation. The operations 800 may be performed by a system, such as client computing system 502 of FIG. 5. In some implementations, the operations 800 may be performed by a browser application 518 and/or a universal install engine 522 of the client computing system 502. The operations 800 enable the system to provide the benefits of an installable web application for any website, regardless of whether the website meets legacy criteria or provides an installation process. At step 802 the system receives an instruction to install a web application. The instruction may be received in response to user selection of an install control. The install control may be an install control surfaced by the system, e.g., as described in FIG. 7. The install control may be an install control provided by the website the user is visiting. At step 804 the system determines whether or not the website is associated with a manifest file. A manifest file can be identified in the markup (HTML) code of the webpage. For example, the location of a manifest file can be identified in a <head> section of the webpage using a link tag (e.g, <<link rel=“manifest” href=“manifest.json” />. Put another way, the system may determine whether or not a manifest file exists for the website. If the website is not associated with a manifest file, at operation 806 the system generates a default manifest file for the website. The system may generate the manifest file using information from the website, such as the page title, icon, and current resource locator, as described herein. At step 808 the system may add default offline page elements to the manifest file, as described herein. At step 810 the system may complete the installation of the web application by storing the newly generated manifest file at the computing system. Installation may include adding the icon identified in the manifest file to an application selector. Installation may include adding the icon identified in the manifest file to a home screen/desktop of the computing system. The user may open/launch the installable web application by selecting the icon, e.g., from the application selector and/or the home screen/desktop.

If the website is associated with the manifest file, at operation 812 the system may determine whether the manifest file needs default offline functionality. The manifest file may need default offline functionality when one or more offline page elements lack (does not include) values in the manifest file. In some implementations, the manifest file may not need default offline functionality when the manifest file includes a default offline flag set (e.g., a default_offline_page flag is FALSE in the manifest file). If the manifest does not need default offline functionality, at step 810 the system may complete the installation of the web application. If the manifest needs default offline functionality, at step 808 the system may add default offline page elements to the manifest file, as described herein. At step 810 the system may complete the installation of the web application.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor. Disclosed operations may be executed in a different order than that shown, or in a parallel, or overlapping fashion.

To provide for interaction with a user, the systems and techniques described here can be implemented on a computer having a display device (e.g., a monitor or touch-sensitive display) for displaying information to the user and a keyboard and a pointing device (e.g., a mouse, trackball, touchpad, stylus, digit, etc.) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of tasks performed by computer programs running on the respective computers.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the implementations disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified. It is to be understood that terminology employed herein is for the purpose of describing particular aspects, and is not intended to be limiting. On the contrary, this patent covers all methods, apparatus and articles of manufacture fairly falling within the scope of the claims of this patent.

In some aspects, the techniques described herein relate to a non-transitory computer-readable medium storing instructions that, when executed by at least one processor of a computing device, causes the computing device to execute a browser application that performs operations including: determining whether a domain of a webpage meets installable application criteria and includes an install method provided by the domain; and in response to determining that the domain includes a webpage that meets the installable application criteria and does not include the install method, providing an install control configured to initiate installation of a web application corresponding to the webpage displayed on the computing device.

In some aspects, the techniques described herein relate to a non-transitory computer-readable medium, wherein the installable application criteria includes non-existence of a manifest file associated with the domain and the webpage is a root of origin page.

In some aspects, the techniques described herein relate to a non-transitory computer-readable medium, wherein the operations further include: receiving selection of the install control; generating a manifest file for the domain; and using the manifest file to install the web application on the computing device.

In some aspects, the techniques described herein relate to a non-transitory computer-readable medium, wherein generating the manifest file includes: identifying a page title for the webpage; identifying an icon associated with the webpage; and adding the page title and the icon to the manifest file.

In some aspects, the techniques described herein relate to a non-transitory computer-readable medium, wherein the installable application criteria includes legacy criteria.

In some aspects, the techniques described herein relate to a non-transitory computer-readable medium, wherein the installable application criteria includes existence of a manifest file associated with the domain.

In some aspects, the techniques described herein relate to a non-transitory computer-readable medium, wherein the install control is provided as part of a confirmation window generated in response to receiving an instruction to save a resource locator of the webpage in a saved resource storage.

In some aspects, the techniques described herein relate to a non-transitory computer-readable medium, wherein the install control is provided in an address bar area of a browser application displaying the webpage.

In some aspects, the techniques described herein relate to a non-transitory computer-readable medium storing instructions that, when executed by at least one processor of a computing device, causes the computing device to execute a browser application that performs operations including: receiving instructions to install a web application; determining whether the web application is associated with a manifest file; generating a default manifest file for the web application in response to determining that the web application is not associated with a manifest file; and installing the web application on the computing device using the default manifest file.

In some aspects, the techniques described herein relate to a non-transitory computer-readable medium, wherein generating the default manifest file includes identifying a page title for the web application and using the page title as an application name in the default manifest file.

In some aspects, the techniques described herein relate to a non-transitory computer-readable medium, wherein generating the default manifest file includes identifying an icon for the web application and using the icon as an application icon in the default manifest file.

In some aspects, the techniques described herein relate to a non-transitory computer-readable medium, wherein generating the default manifest file includes identifying a current resource identifier for the web application and using the current resource identifier as a start resource identifier in the default manifest file.

In some aspects, the techniques described herein relate to a non-transitory computer-readable medium, wherein the current resource identifier represents a root of origin.

In some aspects, the techniques described herein relate to a non-transitory computer-readable medium, the operations further including: determining that the current resource identifier represents a root of origin; and in response to determining that the current resource identifier is a root of origin and that a domain of the current resource identifier is not associated with a manifest file, providing an install control.

In some aspects, the techniques described herein relate to a non-transitory computer-readable medium, the operations further including: providing default values for offline page elements in the default manifest file.

In some aspects, the techniques described herein relate to a non-transitory computer-readable medium, the operations further including: determining, subsequent to installing the web application, that the web application is associated with a manifest file associated with a domain of the web application; and providing an update dialog configured to: display an icon from the default manifest file and an icon from the manifest file associated with the domain, display an application name from the default manifest file and an application name from the manifest file associated with the domain, and provide a control for rejecting the manifest file associated with the domain.

In some aspects, the techniques described herein relate to a non-transitory computer-readable medium storing instructions that, when executed by at least one processor of a computing device, causes the computing device to execute a browser application that performs operations including: determining whether a manifest file associated with a domain does not include one or more offline page elements; and in response to determining that the manifest file does not include one or more offline page elements, providing default values for the one or more offline page elements.

In some aspects, the techniques described herein relate to a method including: determining whether a domain of a webpage displayed on the computing device meets installable application criteria and includes an install method provided by the domain; and in response to determining that the domain includes a webpage that meets the installable application criteria and does not include the install method, providing an install control configured to initiate installation of a web application corresponding to the webpage displayed on the computing device.

In some aspects, the techniques described herein relate to a method, wherein the installable application criteria includes non-existence of a manifest file associated with the domain and the webpage is a root of origin page.

In some aspects, the techniques described herein relate to a method, further including: receiving selection of the install control; generating a manifest file for the domain; and using the manifest file to install the web application on the computing device.

In some aspects, the techniques described herein relate to a method, wherein generating the manifest file includes: identifying a page title for the webpage; identifying an icon associated with the webpage; and adding the page title and the icon to the manifest file.

In some aspects, the techniques described herein relate to a method, wherein the installable application criteria includes legacy criteria.

In some aspects, the techniques described herein relate to a method, wherein the installable application criteria includes existence of a manifest file associated with the domain.

In some aspects, the techniques described herein relate to a method, wherein the install control is provided as part of a confirmation window generated in response to receiving an instruction to save a resource locator of the webpage in a saved resource storage.

In some aspects, the techniques described herein relate to a method, wherein the install control is provided in an address bar area of a browser application displaying the webpage.

In some aspects, the techniques described herein relate to a method including: receiving instructions to install a web application; determining whether the web application is associated with a manifest file; generating a default manifest file for the web application in response to determining that the web application is not associated with a manifest file; and installing the web application on the computing device using the default manifest file.

In some aspects, the techniques described herein relate to a method, wherein generating the default manifest file includes identifying a page title for the web application and using the page title as an application name in the default manifest file.

In some aspects, the techniques described herein relate to a method, wherein generating the default manifest file includes identifying an icon for the web application and using the icon as an application icon in the default manifest file.

In some aspects, the techniques described herein relate to a method, wherein generating the default manifest file includes identifying a current resource identifier for the web application and using the current resource identifier as a start resource identifier in the default manifest file.

In some aspects, the techniques described herein relate to a method, wherein the current resource identifier represents a root of origin.

In some aspects, the techniques described herein relate to a method, further including: determining that the current resource identifier represents a root of origin; and in response to determining that the current resource identifier is a root of origin and that a domain of the current resource identifier is not associated with a manifest file, providing an install control.

In some aspects, the techniques described herein relate to a method, further including: providing default values for offline page elements in the default manifest file.

In some aspects, the techniques described herein relate to a method, further including: determining, subsequent to installing the web application, that the web application is associated with a manifest file associated with a domain of the web application; and providing an update dialog configured to: display an icon from the default manifest file and an icon from the manifest file associated with the domain, display an application name from the default manifest file and an application name from the manifest file associated with the domain, and provide a control for rejecting the manifest file associated with the domain.

In some aspects, the techniques described herein relate to a method including: determining whether a manifest file associated with a domain does not include one or more offline page elements; and in response to determining that the manifest file does not include one or more offline page elements, providing default values for the one or more offline page elements.

In some aspects, the techniques described herein relate to a method, further including: receiving selection of an install control for a web application; and using the manifest file to install the web application on the computing device.

In some aspects, the techniques described herein relate to a method, wherein determining that the manifest file does not include one or more offline page elements a manifest file for the domain includes: determining that the domain lacks a manifest file, wherein in response to determining that the domain lacks a manifest file, the operations further include generating the manifest file for the domain.

In some aspects, the techniques described herein relate to a method, wherein determining that the manifest file does not include one or more offline page elements a manifest file for the domain includes: determining that a web application using the manifest file is installed on the computing device and the web application lacks an offline experience powered by a service worker with a fetch event handler.

In some aspects, the techniques described herein relate to a method, wherein determining that the manifest file does not include one or more offline page elements a manifest file for the domain includes: determining whether a default offline page flag in the manifest file has a value of false; wherein providing the default values occurs in response to determining that the default offline page flag has a value that is not false.

In some aspects, the techniques described herein relate to a system computing device including: at least one processor; and a memory storing instructions that, when executed by the at least one processor, causes the computing device to execute a browser application that performs the method to 21.

In some aspects, the techniques described herein relate to a non-transitory computer-readable medium storing instructions that, when executed by at least one processor 1 to 21. In one aspect, a non-transitory computer-readable medium stores instructions that, when executed by a processor on a receiving computing device, causes the receiving computing device to perform any of the methods disclosed herein.

In one aspect, a computing device can be configured with at least one processor and memory storing instructions that, when executed by the at least one processor, performs any of the methods disclosed herein.

1. A method comprising:
determining whether a domain of a webpage displayed on [[the]] a computing device meets installable application criteria and includes an install method provided by the domain; and
in response to determining that the domain includes a webpage that meets the installable application criteria and does not include the install method, providing an install control configured to initiate installation of a web application corresponding to the webpage displayed on the computing device.

2. The method of claim 1, wherein the installable application criteria includes non-existence of a manifest file associated with the domain and the webpage is a root of origin page.

3. The method of claim 2, further comprising:
receiving selection of the install control;
generating a manifest file for the domain; and
using the manifest file to install the web application on the computing device.

4. The method of claim 3, wherein generating the manifest file includes:
identifying a page title for the webpage;
identifying an icon associated with the webpage; and
adding the page title and the icon to the manifest file.

5. The method of claim 1, wherein the installable application criteria includes legacy criteria.

6. The method of claim 1, wherein the installable application criteria includes existence of a manifest file associated with the domain.

7. The method of claim 1, wherein the install control is provided as part of a confirmation window generated in response to receiving an instruction to save a resource locator of the webpage in a saved resource storage.

8. The method of claim 1, wherein the install control is provided in an address bar area of a browser application displaying the webpage.

9. A method comprising:
receiving instructions to install a web application on a computing device;
determining whether the web application is associated with a manifest file;
generating a default manifest file for the web application in response to determining that the web application is not associated with a manifest file; and
installing the web application on the computing device using the default manifest file.

10. The method of claim 9, wherein generating the default manifest file includes identifying a page title for the web application and using the page title as an application name in the default manifest file.

11. The method of claim 9, wherein generating the default manifest file includes identifying an icon for the web application and using the icon as an application icon in the default manifest file.

12. The method of claim 9, wherein generating the default manifest file includes identifying a current resource identifier for the web application and using the current resource identifier as a start resource identifier in the default manifest file.

13. The method of claim 12, wherein the current resource identifier represents a root of origin.

14. The method of claim 13, further comprising:
determining that the current resource identifier represents a root of origin; and
in response to determining that the current resource identifier is a root of origin and that a domain of the current resource identifier is not associated with a manifest file, providing an install control.

15. The method of claim 9, further comprising:
providing default values for offline page elements in the default manifest file.

16. The method of claim 9, further comprising:
determining, subsequent to installing the web application, that the web application is associated with a manifest file associated with a domain of the web application; and
providing an update dialog configured to:
display an icon from the default manifest file and an icon from the manifest file associated with the domain,
display an application name from the default manifest file and an application name from the manifest file associated with the domain, and
provide a control for rejecting the manifest file associated with the domain.

17. A method comprising:
determining whether a manifest file associated with a domain does not include one or more offline page elements; and
in response to determining that the manifest file does not include one or more offline page elements, providing default values for the one or more offline page elements.

18. The method of claim 17, further comprising:
receiving selection of an install control for a web application; and
using the manifest file to install the web application on a computing device.

19. The method of claim 18, wherein determining that the manifest file does not include one or more offline page elements a manifest file for the domain includes:
determining that the domain lacks a manifest file,
wherein in response to determining that the domain lacks a manifest file, and the method further comprises generating the manifest file for the domain.

20. The method of claim 17, wherein determining that the manifest file does not include one or more offline page elements includes:
determining that a web application using the manifest file is installed on a computing device and the web application lacks an offline experience powered by a service worker with a fetch event handler.

21. The method of claim 20, wherein determining that the manifest file does not include one or more offline page elements includes:
determining whether a default offline page flag in the manifest file has a value of false;
wherein providing the default values occurs in response to determining that the default offline page flag has a value that is not false.

22. (canceled)

23. (canceled)
